(19) United States
(12) Patent Application Publication
(10) Pub. No.: US 2003/0090553 A1
(43) Pub. Date: May 15, 2003

(54) Ink cartridge used with an ink jet printer

(75) Inventors: Myung-song Jung, Gyeonggi-do (KR); Young-su Lee, Gyeonggi-do (KR); Jeong-seon Kim, Gyeonggi-do (KR); Moo-youl Kim, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/287,817

(22) Filed: Nov. 5, 2002

(30) Foreign Application Priority Data
Nov. 5, 2001 (KR) 2001-68632

(51) Int. Cl. B41J 2/175

(52) U.S. Cl. 347/86

(57) ABSTRACT

An ink cartridge used with an ink jet printer. The ink cartridge has an ink reservoir and a housing to cover the ink reservoir with a negative pressure maintenance unit therebetween to maintain the inner pressure of the ink reservoir under a negative pressure. Since the negative pressure maintenance unit does not contact ink in the ink reservoir, the negative pressure maintenance unit does not corrode. In addition, the negative pressure maintenance unit is installed between the housing and the ink reservoir while occupying a small space, and thus improving the filling efficiency of ink in the ink reservoir.

### CROSS-REFERENCE TO RELATED APPLICATIONS

This application claims the benefit of Korean Application No. 2001-68632, filed Nov. 5, 2001, in the Korean Intellectual Property Office, the disclosure of which is incorporated herein by reference.

### BACKGROUND OF THE INVENTION

1. Field of the Invention

The present invention relates to an ink cartridge used with an ink jet printer, and more particularly, to an ink cartridge used to maintain the inside of an ink reservoir under a proper negative pressure.

2. Description of the Related Art

An ink cartridge used with an ink jet printer generally reserves ink to discharge ink droplets through a print head so that a colored image is printed on a sheet.

The ink cartridge requires a device to maintain the inside of an ink reservoir under a negative pressure in order to prevent an excessive amount of ink from leaking through the print head in a printing state, or a wetting occurrence at the print head in an idle state.

FIG. 1 illustrates an ink cartridge disclosed in U.S. Pat. No. 5,541,632. Referring to FIG. 1, the ink cartridge includes a housing and an ink reservoir arranged in the housing to reserve ink, while having a negative pressure maintenance unit 30. The housing includes a frame 10, and side plates 12 and 14 to seal both sides of the frame 10. The ink reservoir is sealed by flexible walls 22 and 24, which may be transformed while maintaining the inside of the ink reservoir in a sealed state. The negative pressure maintenance unit 30 maintains the inside of the ink reservoir under a proper negative pressure. Thus, ink is prevented from dripping through a print head 13 when discharging the ink from the ink reservoir through the print head 13 by passing through a filter 18 or when reserving the ink in the ink reservoir. In this case, the negative pressure maintenance unit 30 has a bow spring 31 and plates 32 and 34 to support the bow spring 31.

In the ink cartridge of the above configuration, since the bow spring 31 directly contacts the ink reserved in the ink reservoir, the bow spring 31 may corrode by chemical reaction with the ink.

Accordingly, preventing the bow spring 31 from corroding is required. However, forming the bow spring 31 by using a material which does not react with inks limits the range of materials for the bow spring 31 and increases the price of the selected material. An alternative plan for changing the main element and additives of the ink also limits the selecting range for ink and increases the price of the ink.

### SUMMARY OF THE INVENTION

Accordingly, it is an objective of the present invention to provide an ink cartridge used with an ink jet printer, which prevents a negative pressure maintenance unit from corroding and improves the filling efficiency of ink.

Additional objects and advantages of the invention will be set forth in part in the description which follows and, in part, will be obvious from the description, or may be learned by practice.

The foregoing and other objects of the present invention are achieved by providing an ink cartridge used with an ink jet printer having an ink reservoir to reserve ink, a housing to cover the ink reservoir, and a negative pressure maintenance unit to maintain the inner pressure of the ink reservoir under a negative pressure. The reservoir includes a base plate, a cover plate separated from the base plate, and flexible walls interposed between the base plate and the cover plate to form a sealed space to reserve ink. Here, the negative pressure maintenance unit includes at least one elastic member to be interposed between the housing and the cover plate.

In an aspect of the invention, the elastic member is a leaf spring to maintain the inner pressure of the ink reservoir under the negative pressure by applying an elastic restoring force in a pulling direction of the cover plate.

The leaf spring has a housing fixing portion fixed to the housing, plate fixing portions fixed to the cover plate, and connecting portions to integrally connect the housing fixing portion and plate fixing portion.

In another aspect of the invention, the housing is formed by fixing first and second body portions that are facing each other or by fixing a wall body having a through hole and a cover to seal one side of the wall body, so that the housing is coupled with the base plate to cover the ink reservoir. In another aspect of the invention, the housing is formed of one selected from a sheet metal and structural polymer.

### BRIEF DESCRIPTION OF THE DRAWINGS

These and other objects and advantages of the invention will become apparent and more readily appreciated from the following description of the embodiments, taken in conjunction with the accompanying drawings of which:

FIG. 1 is a separate perspective view illustrating a conventional ink cartridge;

FIG. 2 is a sectional view illustrating an ink cartridge according to an embodiment of the present invention;

FIG. 3 is a sectional view illustrating the ink cartridge according to the embodiment of FIG. 2 along the cutting plane line II-II of FIG. 2;

FIGS. 4A through 4C illustrate an aspect of a leaf spring used in the ink cartridge according to the embodiment of FIG. 2, in particular, an initial state, and before and after the operation of the leaf spring;

FIGS. 5A through 5C illustrate the leaf spring used in the ink cartridge according to another aspect of the present invention, in particular, an initial state, and before and after the operation of the leaf spring, respectively;

FIGS. 6A through 6C illustrate another aspect of the leaf spring used in the ink cartridge according to the embodiment of FIG. 2, in particular, an initial state, and before and after the operation of the leaf spring, respectively;

FIG. 7 illustrates a housing used in the ink cartridge according to another embodiment of the present invention; and

FIG. 8 illustrates a housing used in the ink cartridge according to yet another embodiment of the present invention.

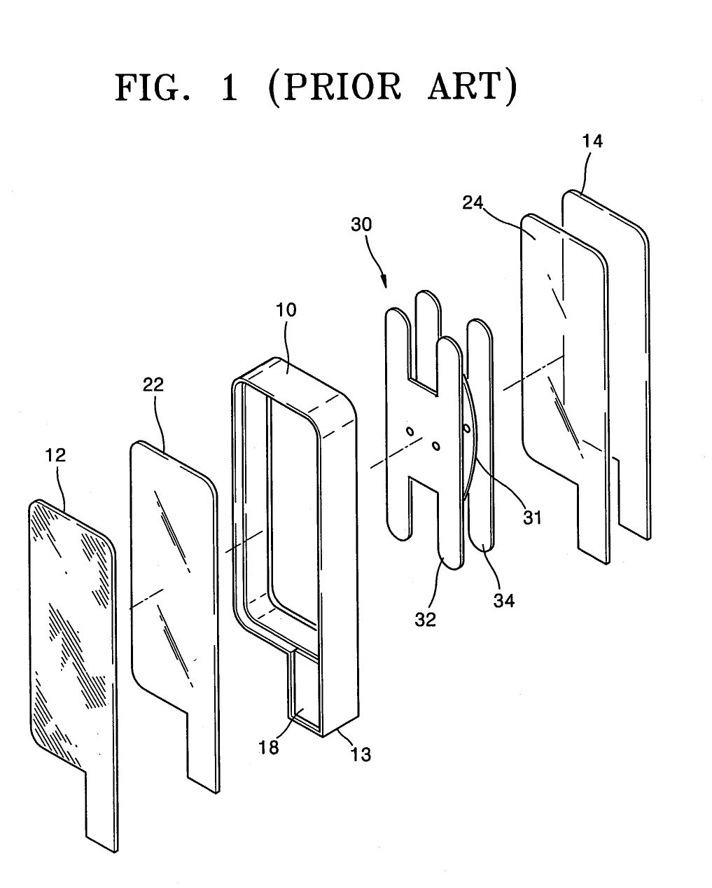

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

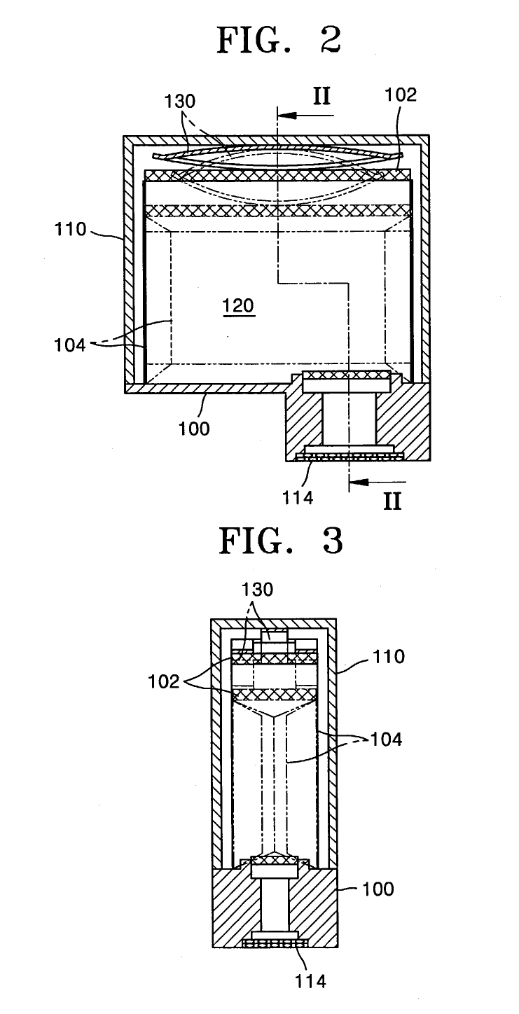

FIG. 2 is a sectional view illustrating an ink cartridge according to an embodiment of the present invention, and FIG. 3 is a sectional view illustrating the ink cartridge along the cutting plane line II-II of FIG. 2. Referring to FIGS. 2 and 3, the ink cartridge includes an ink reservoir 120, a housing 110, and a leaf spring 130 as a negative pressure maintenance unit.

The ink reservoir 120 contains a base plate 100, a cover plate 102, and flexible walls 104 to seal a space between the plates 100 and 102. In this case, the cover plate 102 moves vertically according to the amount of ink in the ink reservoir 120. The flexible walls 104 formed of a flexible material are attached to the edges of the base plate 100 and the cover plate 102 that face each other, so that a sealed space is formed.

The housing 110 has an opening in the area of which the housing 110 is coupled with the base plate 100 by welding, i.e., a thermal or ultrasonic welding, or by using a combining unit, i.e., a screw or hook, so that the housing 110 with the base plate 100 covers the ink reservoir 120.

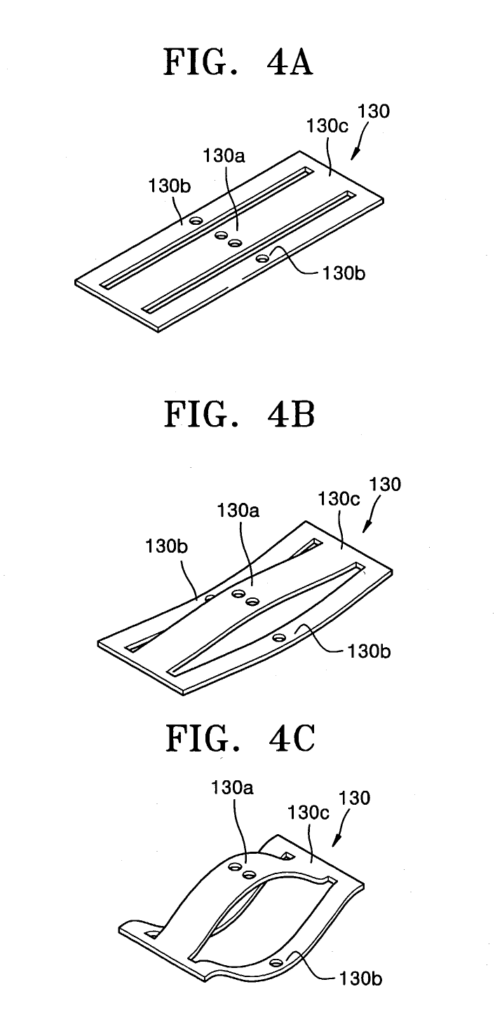

The housing 110 and the cover plate 102 of the ink reservoir 120 are arranged with the leaf spring 130 therebetween . The initial state and before and after operation states of the leaf spring 130 are illustrated in FIGS. 4A through 4C. Referring to FIGS. 4A through 4C, the leaf spring 130 includes a housing fixing portion 130a fixed to the housing 110, plate fixing portions 130b fixed to the cover plate 102, and connecting portions 130c to connect the fixing portions 130a and 130b. In this case, the housing and plate fixing portions 130a and 130b are fixed to the housing 110 and the cover plate 102 by a welding method or by using a combining unit like a screw or hook, respectively. The leaf spring 130 is flat in the initial state. When installing the leaf spring 130 in the ink cartridge, the leaf spring 130 is transformed toward an operation direction by a small amount, as illustrated in FIG. 4B. Since strain energy accumulates in the leaf spring 130 due to the transformation, the strain energy generates an elastic restoring force to pull the cover plate 102 of the ink reservoir 120. Consequently, a negative pressure, under an external atmospheric pressure, is formed in the ink reservoir 120. As the ink is discharged through a print head 114 and the amount of ink in the ink reservoir 120 decreases, the flexible walls 104 contract toward an inner direction, as illustrated by dotted lines in FIGS. 2 and 3. Accordingly, the cover plate 102 moves toward the base plate 100. In this case, the transformation of the leaf spring 130 increases to move the cover plate 102, so that the negative pressure in the ink reservoir 120 is maintained within a predetermined range. FIG. 4C illustrates the final state of the leaf spring 130.

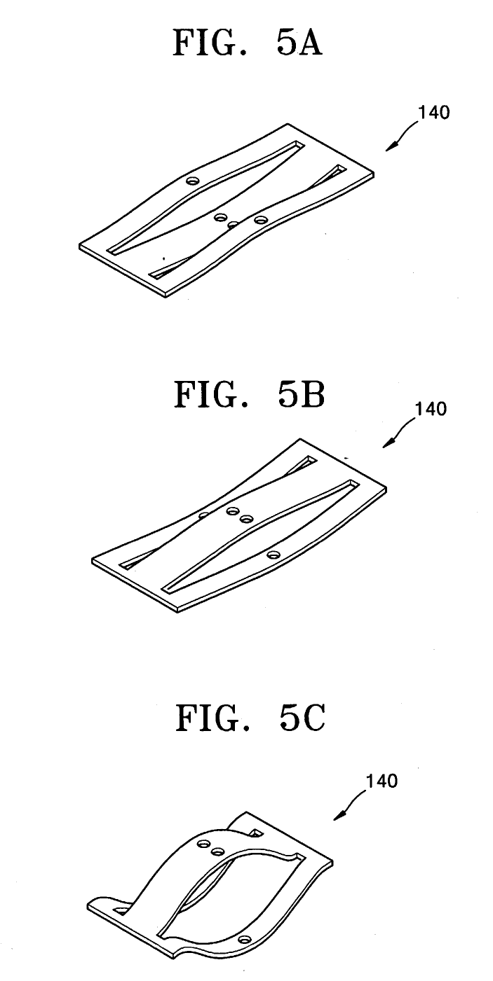

FIGS. 5A through 5C illustrate another aspect of a leaf spring used in the ink cartridge according to an embodiment of the present invention, in particular, an initial, uninstalled state of the leaf spring, and states of the leaf spring before and after operation, respectively. Prior to installation, the leaf spring 140 is transformed by a small amount in an opposite direction from the operation direction in, as illustrated in FIG. 5A. When installing the leaf spring 140 in the ink cartridge, the leaf spring 140 is transformed toward an operation direction, as illustrated in FIG. 5B. Accordingly, a stronger restoring force than that of the leaf spring 130 shown in FIG. 4B is generated to pull the cover plate 102. FIG. 5C illustrates the final state of the leaf spring 140.

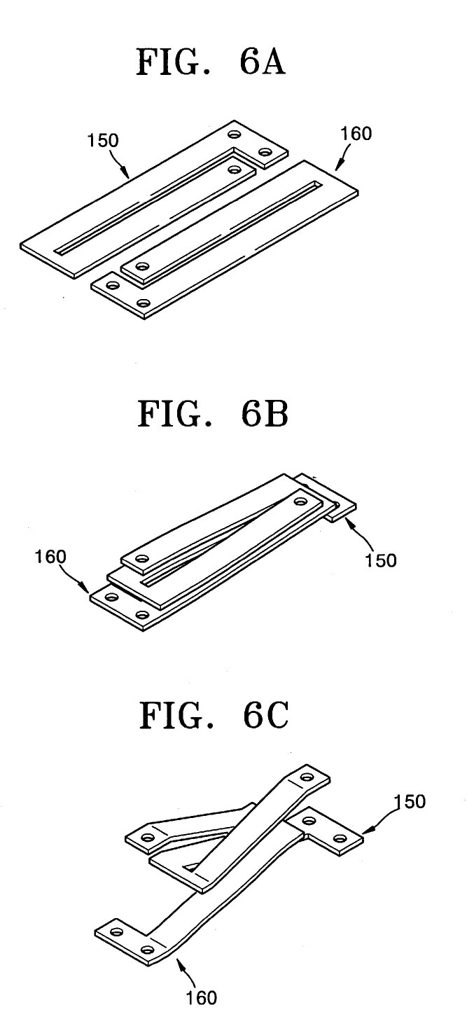

FIGS. 6A through 6C illustrate another aspect of a leaf spring used in the ink cartridge according to an embodiment of the present invention. The leaf spring is formed by overlapping two identical leaf springs 150 and 160 inversely facing each other. The leaf springs 150 and 160 are overlapped in the state illustrated in FIG. 6B so that a restoring force is applied to pull the cover plate 102. FIG. 6C illustrates the final state of the leaf springs 150 and 160.

Although a few types of leaf springs used in the ink cartridge are described above, various types of leaf springs may be used without departing from the scope of the present invention.

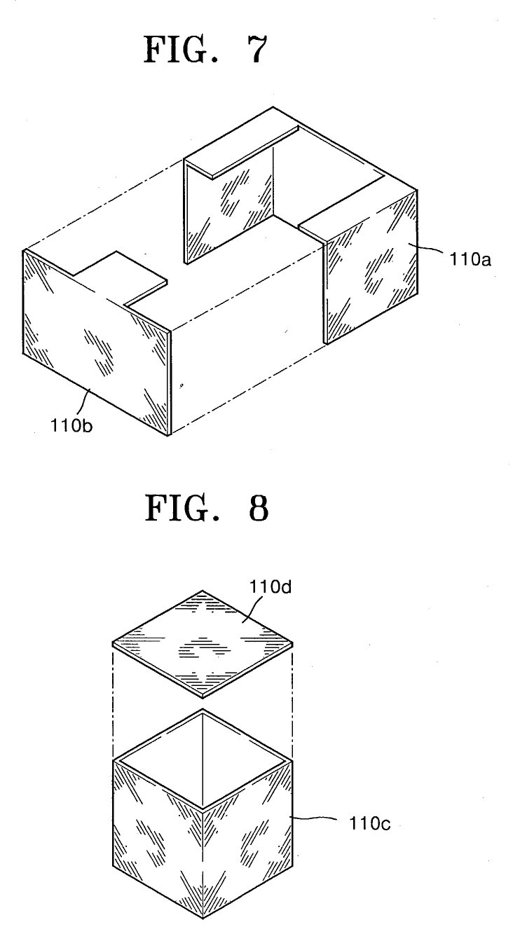

In addition, another housing, other than an integral type housing, may be formed by coupling corresponding portions of the housing, as illustrated in FIGS. 7 and 8. FIG. 7 illustrates the housing formed by coupling first and second body portions 110a and 110b that are facing each other, to cover the ink reservoir 120 in FIG. 2. The first body portion 110a has an opened side and an upper surface with an opened portion. The second body portion 110b is formed in a shape to seal the opened side and the opened portion of the upper surface of the first body portion 110a. The first and second body portions 110a and 110b are coupled to form the housing having an opened lower surface. The first and second body portions 110a and 110b are coupled by a welding method, such as thermal welding or ultrasonic welding, or by a mechanical coupling method using a screw or hook. In this case, the housing is formed of a processed sheet metal or structural polymer. In FIG. 8, a housing is formed by coupling a wall body 110c having a through hole and a cover 110d to seal the upper portion of the wall body 110c. In this case, the material and coupling method for the wall body 110c and the cover 110d are the same as those for the housing illustrated in FIG. 7. Although a few types of housings used in the ink cartridge according to the present invention are described above, various types of housings may be formed without departing from the range of the present invention.

Since the ink is filled only in the ink reservoir of the ink cartridge according to the present invention, changes in the physical property of the ink by vaporization of the ink are prevented. Since the inner pressure of the ink reservoir does not vary while storing the ink cartridge for a long time or at a high or low temperature, it is unlikely that the ink drips. Moreover, the leaf spring is located outside of the ink reservoir, so that the leaf spring does not corrode while having the possibility to freely select the ink and the material for the leaf spring. The leaf spring occupies a small space between the housing and ink reservoir, so that the filling efficiency of ink improves.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An ink cartridge used with an ink jet printer, the ink cartridge having an ink reservoir to reserve ink, a housing to cover the ink reservoir, and a negative pressure maintenance unit to maintain the inner pressure of the ink reservoir under a negative pressure, wherein the reservoir comprises:
a base plate;
a cover plate separated from the base plate; and
flexible walls interposed between the base plate and the cover plate to form a sealed space to reserve ink,
the negative pressure maintenance unit includes at least one elastic member to be interposed between the housing and the cover plate.

2. The ink cartridge of claim 1, wherein the elastic member is a leaf spring to maintain the inner pressure of the ink reservoir under the negative pressure by applying an elastic restoring force in a pulling direction of the cover plate.

3. The ink cartridge of claim 2, wherein the leaf spring has:
a housing fixing portion fixed to the housing;
plate fixing portions fixed to the cover plate; and
connecting portions to integrally connect the housing fixing portion and plate fixing portion.

4. The ink cartridge of claim 1, wherein the housing is formed by fixing first and second body portions that are facing each other, so that the housing is coupled with the base plate to cover the ink reservoir.

5. The ink cartridge of claim 1, wherein the housing is formed by fixing a wall body having a through hole and a cover to seal one side of the wall body, so that the housing is coupled with the base plate to cover the ink reservoir.

6. The ink cartridge of claim 4, wherein the housing is formed of one selected from a sheet metal and structural polymer.

7. The ink cartridge of claim 5, wherein the housing is formed of one selected from a sheet metal and structural polymer.

8. The ink cartridge of claim 3, wherein the housing fixing portion and the plate fixing portion are fixed to the housing and the cover plate, respectively, by welding.

9. The ink cartridge of claim 3, wherein the housing fixing portion and the plate fixing portion are fixed to the housing and the cover plate, respectively, by screws.

10. The ink cartridge of claim 3, wherein the housing fixing portion and the plate fixing portion are fixed to the housing and the cover plate, respectively, by hooks.

11. The ink cartridge of claim 2, wherein the cover plate moves toward the base plate.

12. The ink cartridge of claim 2, wherein the leaf spring is formed by overlapping two leaf springs inversely facing each other to provide a restoring force to pull the cover plate.

13. The ink cartridge of claim 4, wherein the first and second body portions are coupled to each other by thermal welding, ultrasonic welding, or by using screws or hooks.

14. An ink cartridge comprising:
an ink reservoir having a cover thereon;
a housing enclosing the reservoir and cover; and
an elastic member interposed between the housing and the cover to maintain a constant negative pressure within the ink reservoir.
